(19) United States
(12) Patent Application Publication
(10) Pub. No.: US 2009/0117389 A1
(43) Pub. Date: May 7, 2009

(54) Coating Materials with Oxygen Scavenger and/or Oxygen Indicator Function for Coating or Bonding and Products Produced Therewith

(75) Inventors: Sabine Amberg-Schwab, Erlabrunn (DE); Annette Burger, Wurzburg (DE); Ulrike Weber, Waldbrunn (DE); Rainer Xalter, Freiburg (DE); Somchith Nique, Eisingen (DE)

Correspondence Address: DORITY & MANNING, P.A., POST OFFICE BOX 1449, GREENVILLE, SC, 29602-1449, US

(73) Assignee: Fraunhofer-Gesellschaft Zur Foerderung Der Angewandten Forschung, Muenchen (DE)

(21) Appl. No.: 12/092,133

(22) PCT Filed: Nov. 6, 2006
(86) PCT No.: PCT/EP2006/068152

§ 371 Date: Oct. 23, 2008

(30) Foreign Application Priority Data
Nov. 7, 2005 (DE) 10 2005 052 891.0
Nov. 7, 2005 (DE) 20 2005 017 608.7
Jul. 19, 2006 (DE) 10 2006 033 489.2

(51) Int. Cl. B32B 27/40; C09K 3/00; B32B 37/00; B32B 27/00

(52) U.S. Cl. 428/423.1; 252/188.28; 428/447; 428/500

(57) ABSTRACT

The present invention relates to a surface-coating material comprising a matrix of an at least partly organic polymer and also at least one component selected from components which, following appropriate triggering, are reactive towards oxygen. These components are preferably oxygen-consuming and/or they are able to indicate the presence of oxygen. The surface-coating material is suitable in particular as a coating material or as an adhesive. The invention further relates to a substrate provided with a coating of the stated surface-coating material, to a composite material composed of a plurality of layers which have been joined using this surface-coating material, and to production processes therefor. In one particular embodiment the matrix is formed from an organic-inorganic hybrid polymer; alternatively it may have a purely organic construction. The component that is reactive towards oxygen may either be embedded in the matrix or incorporated covalently therein.

Almost unnoticeably for most consumers, more and more products have found their way recently into the supermarket shelves whose packagings are provided in the professional world with the keyword “active packaging”. This concept combines such different systems as oxygen consumer (“oxygen scavenger”) moisture regulators, CO₂ emitters, CO₂ absorbers, ethylene absorbers and many more. The particular effect and the resulting advantage regarding product quality and/or extension of the self life can not be recognized as a rule by the customer. Systems that are invisible to the customer and integrated into the packaging nevertheless are becoming increasingly more common. One example should suffice here: Wherever beer is offered in PET bottles, it can be reliably assumed that an oxygen scavenger is contained in the bottle material or bottle closure. Only in this manner can an appropriate storage time be guaranteed for this highly oxidation-sensitive product in spite of the oxygen permeability of PET, which is much higher in comparison to glass.

Oxygen can contribute in many ways to the spoiling of food or to functional problems. It does not act directly in an oxidative manner on certain product constituents but rather makes the growth of aerobic microorganisms possible in many instances so that as a consequence color, taste, consistency or the like are adversely effected, the nutrient value might decrease and, in addition, there is the danger of microbial contamination. The function of oxygen scavengers can be on the one hand to eliminate the residual oxygen content of 0.5-2% remaining during packaging under protective gas (so-called “MAP”, modified atmosphere packaging) in the head area as well as to eliminate the oxygen produced in the product in the shortest possible time. On the other hand, they should absorb the oxygen permeating through the barrier packaging over the longest possible time and thus significantly extend on the whole the shelf time of oxidation-sensitive products.

In order to obtain information about the degree of depletion of the scavenger and about the actual oxygen concentration in the packaging, it can be desirable that an indicator with a corresponding function is additionally integrated in the packaging.

Compounds that absorb oxygen and chemically bind it in a permanent manner are designated as oxygen scavengers. These scavengers have manifold functions. For example, they can consist in packagings in producing and maintaining a practically oxygen-free atmosphere in order to ensure a prolonged shelf life of the packaged substance. To this end they must on the one hand remove residual oxygen located in the head area of the packaging as rapidly as possible. On the other hand, they constitute, to the extent that they are integrated in the outer packaging material, an active barrier against oxygen migrating from the outside into the packaging. Scavengers are also interesting for other areas, e.g., for industrial packagings or compact parts.

A distinction can be made in principle between two embodiments: the one customary in particular in the Asiatic area is the addition of scavenger-containing sachets (small packages) into the packaging. However, this variant is hardly accepted in Western markets. The more advanced but technically harder to realize embodiment is the incorporation of scavengers in packaging systems such as crown corks, polymer sleets or plastic bottles.

In the previously developed scavengers a distinction can be made between iron-based, sulfite-based, ascorbate-based and enzyme-based systems as well as oxidizable polyamides and ethylenically unsaturated hydrocarbons.

Iron-based scavengers are based on the oxidation of metallic irons to iron(II) hydroxide and iron(III) hydroxide. The reaction requires, in addition to certain promoters that have an accelerating action, moisture in order to start the scavenging process. This creates a trigger mechanism that makes the purposeful activation possible. However, such scavengers are suitable only for products with a high moisture content. Examples and polymers with a worked-in scavenger composition are Oxyguard of Toyo Seikan Kaisha and ShelfPlus O2 of Ciba Specialty Chemicals. The latter can also be processed to sheets as well as to trays in accordance with the embodiment. However, general disadvantages when working powdery scavengers into polymer sheets are the reduced transparency and the deterioration of the mechanical properties of these sheets.

In sulfite-based scavengers the absorption of oxygen takes place under the oxidation of potassium sulfite to sulfate. Here too the activation takes place via moisture. The scavenger mixture is worked into polymers that do not have a sufficiently high water-vapor permeability until at elevated temperatures, e.g., during pasteurization or sterilization. According to patents of the American Can Company crown corks for beer bottles are the primary area of use.

However, more effective than purely sulfite-based systems are ascorbate-based scavengers or mixtures of ascorbate and sulfite. In the latter an oxidation of ascorbic acid to dehydroascorbic acid takes place. Primarily sodium-L-ascorbate is used; however, derivatives of ascorbic acid can also be used. The oxidation reaction is accelerated by catalysts, preferably iron- and copper chelate complexes. Moisture is again the trigger so that here too the use is limited to products with a high water content. Ascorbate-based scavengers are available as sachets as well as worked into crown corks and bottle closures.

As concerns enzyme-based scavengers only one product is on the market, namely, the Bioka Oxygen Absorber of Bioka, that is marketed in sachet form. It is based on the oxidation of glucose to gluconic acid and hydrogen peroxide catalyzed by glucose oxidase, which is rendered harmless by a further enzyme, catalase, in that it is degraded to water and oxygen. The advantages of this system reside in the harmlessness of the natural components regarding food laws.

The oxidizable polymers also include the oxidizable polyamides in addition to the ethylenically unsaturated polymers treated in the next section. Primarily nylon poly-(m-xyxylene adipamide) is used. The activation of the scavenging process takes place via photoinitiation by UV radiation and cobalt is added as oxidation catalyst. Commercially available products based on this principle are used primarily in blends for PET bottles. However, polyamides have the disadvantage that they are incompatible with thermoplastic polymers and at times the heat sealing causes problems.

Ethylenically unsaturated hydrocarbons form the most versatile group of the oxidizable substrates. On the one hand sachets are described in the state of the art that contain unsaturated fatty acids as active component. However, above all, a plurality of oxidizable polymers are contained in this group: Polybutadiene, polyisoprene and their copolymers (U.S. Pat. No. 5,211,875; U.S. Pat. No. 5,346,644) but also acrylates with cycloolefins as side chains (WO 99/48963; U.S. Pat. No. 6,254,804). Only the latter ones were previously actually ready for the market because they offer two decisive advantages over other oxidizable, ethylenically unsaturated polymers: On the one hand the cyclic structure of the olefin hinders the production of low-molecular oxidation products, that have a damaging effect on the quality of the packaged material and are problematic as regards food laws. On the other hand the structure of the polymer is not destroyed by the oxidation process, as is the case for the above-cited polymers, whose material properties deteriorate with an increasing degree of oxidation (WO 99/48963). These resins, all terpolymers of the poly-(ethylene-methacrylate-cyclohexenylmethylacrylate) (EMCM) type, are produced by partial reesterification of the methylacrylate with the appropriate alcohol. They can be used for stiff and flexible packagings and are distinguished by high transparency, high capacity and rapid kinetics. According to data of the producer the oxygen capacity of the sheets is, e.g., 45-78 ccm per gram of sheet; this value can be achieved within a few days after activation of the scavenger function. On account of the UV trigger mechanism these acrylates are suitable for dry as well as for moist products. The oxidation process is cobalt-catalyzed as in the oxidizable polyamides.

The function of quality indicators in food packagings generally consists in giving the producer, merchant or also the consumer information about the quality status of a product. Solutions present in the market comprise on the one hand the temperature-time indicators (TTI), that indicate the exceeding of a certain temperature or record the temperature-time history of a product. In addition, a number of different quality indicators can be comprised in the group of freshness indicators, that give direct information about the degree of freshness of the packaged material. They detect degradation products released during the spoiling of products, or microorganisms and/or their metabolic products. A freshness indicator that indicates volatile amines by a color change is already being used commercially.

The quality indicators can also comprise oxygen indicators that indicate the oxygen content in MAP-barrier packagings that are advantageously combined with an oxygen scavenger. Like the temperature-time indicators, they give only indirect information about the product quality since there is no unambiguous correlation between the oxygen concentration in the packaging and the quality. Although a few attempts at solutions for the topic of oxygen indication in food packagings have been described, only a few commercial products were obtainable in the market in the past. A reversible system is marketed in tablet form that consists of a dye from the group of oxazines or thiazines, reducing saccharides and an alkaline component (U.S. Pat. No. 4,169,811). In the absence of oxygen the dye is completely reduced and upon contact with oxygen the original color rapidly reappears. Oxygen-sensitive inks containing leuco dye for printing packagings (U.S. Pat. No. 6,254,9696) and cellulose impregnated with leuco dye solution (U.S. Pat. No. 4,526,752) are similar developments. Since residual reducing agent is removed in these indicators before the application of the ink or solution, an irreversible color change is obtained in the presence of oxygen so that a one-time exceeding of a critical oxygen concentration results in a permanent signal. However, this has the disadvantage that the application on or the introduction into the packaging must take place under the strict exclusion of oxygen. An alternative to the above is constituted by development attempts to put the dye into an oxygen-sensitive, reduced state after the packaging via photoreduction. This can take place, e.g., via a riboflavin-mediated photoreduction of oxazines or thiazines (WO 95/29394) or the direct photoreduction of quinone dyes and anthraquinone dyes (U.S. Pat. No. 5,958,254). The components can be immobilized in polymers without loss of function. A different concept for the detection of oxygen is based on the oxidation of Fe(II) to Fe(III). The latter forms heavily colored complexes with certain organic molecules such as, e.g., gallic acid. However, this indicator type requires moisture, just as the iron-based scavenger systems, in order to ensure the functionality. Since this concerns an initially reversible process, the oxidation that occurred during processing and packaging can be made retrograde by photoreduction and the system put back into its initial state (WO 98/03866; WO 99/36330).

The previous state of the art has the following disadvantages:
Scavengers are homogeneously worked into the sheet material, which can negatively influence the polymer properties,
There is no scavenger coating with which very different surfaces could be functionalized/activated,
The trigger mechanisms cannot be transferred to all product types (moisture-triggered),
The color reactions in combined scavenger/indicators systems are unfavorable: grey to brownish discoloration,
The systems of the state of the art are for the most part unsuitable for contact with food.

The present invention has the problem of making initial materials for packaging systems and other systems available that, provided with these initial materials, have oxygen-scavenger and/or oxygen-indicator properties without the substances required to this end negatively influencing the main properties of the appropriate bulk materials of the packaging systems or other systems by being homogeneously worked into them.

This problem is solved by making available novel matrix systems (paints) that can be triggered, are capable of being coated and/or bonded and have a reactivity to oxygen (as oxygen scavenger and/or oxygen indicator) and that are in principle suitable as coating material or (laminating) adhesive for any substrate, independently of its chemical composition or geometry, so that they are present on this substrate either as a subsequently hardened or dried layer and/or can connect, e.g., laminate substrates such as sheets or rigid layers to each other.

This means for the scavenger systems a capacity of preferably at least 20 ccm oxygen per gram of oxygen-consuming polymer, united with the most rapid kinetics possible, e.g., in order to rapidly eliminate the residual oxygen in MAP packagings and thus prevent a quality-reducing oxidation of the packaged material. Furthermore, the scavenger effect should last as long as possible in order to continuously absorb the oxygen migrating through the packaging. In addition, from the standpoint of packaging technology a high transparency of bonded/laminated or coated sheets with scavenger function is desirable since the customer prefers products with visible contents. These goals can be realized with transparent coating materials that can be applied via customary coating material application processes as scavenger layers on any substrates, e.g., on sheets, or can be used as laminating material or other bonding materials for bonding such substrates. The advantage of such layers and bonding agents is that they can be used in combination with any sheet materials and other substrate materials and therefore also with materials that are not suitable themselves as matrix systems for scavenger materials, e.g., as migration barriers or food contact layer. The advantages of the coating materials in accordance with the invention are furthermore a frequently better chemical stability and temperature resistance of the resulting layers or bonded/laminated layer composites as well as, in the case of coatings, greater resistance to wear.

In the indicator systems in particular the ability to coat belongs to the requirements made. It should allow tack-free layers to be produced on any substrates. The advantage of such layers is that they can be used in combination with a substrate material and thus also with such materials that are not suitable themselves as matrix systems for indicator systems. The basic goal for the development of indicators is to furnish information about the quality status of the packed product by means of an optically perceptible signal. One possibility for doing this is that the depletion of the scavenger capacity is displayed. If the capacity is designed in such a manner that the residual amount of oxygen in the head area of the packaging does not result in the complete depletion of the scavenger, a change of the indicator in this instance can indicate either a leak in the packaging through which massive oxygen penetrates, or that the permeating oxygen can no longer be trapped as of the time of the change. Therefore, in both instances a rise in the oxygen concentration in the packaging must be reckoned with and the quality of the product endangered. The second possibility is a direct indication of the oxygen concentration actually present. In this variant the indicator should indicate possible quality deficiencies upon reaching a critical concentration of, e.g., ca. 2% oxygen in the head area (as a function of the particular packaged material).

A likewise important requirement from the aspects of packaging technology and engineering technology is that the possibility of the purposeful activation (“triggering”) of the scavenger function as well as of the indicator function must be secured in order to suppress a premature reaction with oxygen during the production, storage, and in the packaging process.

An important point of this invention is the development of suitable matrices for the particular active compounds. This means for scavenger matrices that they offer the possibility of being embedded in a matrix (that can be a purely organic or an inorganic-organic hybrid matrix) or, preferably, of a covalent integration of the oxygen-consuming compound(s) and should allow the scavenging process to take place as efficiently as possible. Indicator matrices must also allow the chemical or physical insertion of the active component(s) and permit an optical signal that can be perceived as distinctly as possible.

The present invention makes a coating material available for the solution of the above problem that contains a matrix of an at least partially organic polymer as well as contains at least one component, selected from components that are reactive to oxygen after suitable triggering. The components that are reactive to oxygen after triggering are preferably selected from components that are oxygen-consuming, or components that can indicate the presence of oxygen. Both cited variants are, each for itself, significant embodiments of the invention. They can also basically be combined with one another even in one and the same coating material or in different coating material layers of the end product.

The coating material of the present invention can preferably be used as a coating material for coating. As an alternative and also in a preferable manner the coating material can be used as bonding agent for bonding preferably layered materials, e.g., as laminating bonding agent. Coating materials for absorbing undesired oxygen as well as material with the aid of which the presence of oxygen is to be indicated are suitable for this purpose. If the coating material is to be used as bonding agent the usage as oxygen scavenger is particularly but not exclusively suitable. However, a bonding agent with oxygen indicator function can be used in such instances in which the layer separating the bonding agent from the possibly oxygen-containing sphere is relatively readily permeable for oxygen. It should be pointed out that the same material can be used for both usages partially but not in all instances. Thus, some layering coating materials harden in air, possibly thermally or with the aid of radiation to a hard, scratchproof coating but are also suitable as bonding agents, e.g., laminating bonding agents, given the adjusting of suitable viscosities.

Different materials can be used for the matrix of the coating material. Inorganic-organic hybrid polymers, e.g., ORMOCERE®, produced according to sol-gel processes from hydrolysable and condensable, optionally organically cross-linkable silanes can be used for the matrix of the coating material, and if necessary other metallic cations can be covalently embedded in the Si—O—Si matrix. The abundantly present patent literature and other literature can be referred to in this regard. Thus, the matrix can be produced, e.g., using a di- or trialkoxysilane, optionally with the additional usage of a metallic alkoxide selected in particular from alkoxides of aluminum, zirconium, titanium or tin.

In a number of instances, especially in the production of coating materials with oxygen indicator function, the matrix can also consist instead of a purely organic polymer material. If a coating material is to be produced, it is a condition that the material is tack-free after drying. Materials suitable for this are, e.g., polyvinyl alcohol and/or a polymer containing methacrylic acid or a polymer based on polyurethane (PUR), that forms the matrix by itself or in substantial parts or in combination with other materials.

In particular when the component that is reactive to oxygen after a suitable triggering is an oxygen-consuming component it can be covalently incorporated in the matrix. It is especially advantageous in this instance to use a silane-bound group as oxygen-consuming component. Alternatively or cumulatively, the oxygen-consuming component can be a compound containing a cyclic olefin, e.g., a cyclohexene group. The latter can be bound via a shorter or longer organic spacer group, e.g., a C₂-C₆ alkylene group, to the backbone of the compound or to a silicon atom.

Alternatively, the component, that can indicate the presence of oxygen after triggering, can be incorporated into the matrix via ionic or Van-der-Waals forces or hydrogen bridge bonds. This matrix can then be, as mentioned above, either an inorganic-organic matrix (e.g., an ORMOCER®) or a purely organic matrix.

A suitable component that can indicate the presence of oxygen after triggering is one in which the oxygen is indicated by a color change, e.g., a leuco dye. Examples for suitable leuco dyes are leuco malachite green and methylene blue. If leuco malachite green is used, the coating material preferably additionally contains acid (protons), a reducing agent and a photosensitizer. For example, ascorbic acid is suitable as reducing agent. Hematoporphyrin IX can be used as photosensitizer. If methylene blue is used, the coating material preferably additionally contains a redox system, for example, ethylene diamine tetraacetic acid and/or riboflavin.

Independently of whether the presence of oxygen is indicated or the coating material is to be used for trapping and removing oxygen, the triggering of the component(s) smoothly takes place with the aid of actinic radiation, preferably in the presence of a photosensitizer.

If the coating materials of the present invention are intended for the food area, appropriate matrices admissible under the food laws are used. These matrices are known to a person skilled in the art. For this area of application, for example, cyclic olefins are suitable as oxygen-consuming component and, for example, and methylene blue as oxygen indicator.

The coating materials of the present invention are suitable not only for applications in the food area but also for other industrial purposes. For example, encapsulation sheets or other packaging materials for OLEDs, solar cells and others can be produced with them.

The coating materials of the present invention are produced as a rule in the presence of water or aqueous solvents to which further components are added as required. For the production sol-gel processes can be used, e.g., to produce matrices of or with hydrolysable and condensable silanes; for this, e.g., condensation catalysts can be added that may, however, also have a function in the matrix like amino silanes. Pure catalysts as well as catalysts having further functions are abundantly known in the state of the art.

In order that the particular coating materials obtain the suitable consistency and viscosity, solvents can be added to them as diluting agents or removed from them as needed. The adhesiveness can also be partially adjusted via the viscosity, and can otherwise also be influenced via other parameters, e.g., the molecule sizes.

Any substrates can be coated with the coating material of the present invention. After drying and/or hardening a substrate is produced that is provided with a stable coating and is suitable for appropriate applications. Thus, rigid or flexible, single-layer or multi-layer packaging materials can be coated with the coating material, e.g., sheets. In the packagings manufactured from them these coatings preferably face the interior of the packaging in order to absorb residual oxygen there or oxygen permeating through the packaging material in the course of time and/or to indicate it and/or a leak that occurred. As an alternative, the coating material can be used as bonding agent with whose aid, e.g., a composite material consisting of at least two layered substances is created. It is preferably a bonding substance that is suitable as laminating bonding agent for producing laminated sheets or the like. Of course, the coating materials of the present invention can also be used as coating as well as (laminating) bonding agent on or in one and the same material. Moreover, it is of course possible to make a (packaging) material available that has a coating with oxygen-consuming functions as well as a coating that has oxygen-indicating functions. The latter can be provided with a coating, for example, on one side of it, optionally the inside, which coating consists of a coating material in accordance with the invention with a component that can indicate the presence of oxygen, which layer is coated over on the inside with a layer produced with a coating material in accordance with the invention and containing an oxygen-consuming component. The two layers can of course also be applied in the inverse sequence.

In an especially preferred embodiment of the present invention the substrate or composite material coated or bonded with the coating material in accordance with the invention additionally contains at least one layer or sheet that inhibits or prevents the passage of oxygen (a so-called passive barrier; in contrast thereto, oxygen scavengers function as active barriers). Such layers and sheets are known in the state of the art. A material that is well suited for such layers is an inorganic-organic hybrid polymer. This layer is preferably formed as the outermost layer of the finally formed layer material or composite material.

The attached figures further illustrate the invention, in which

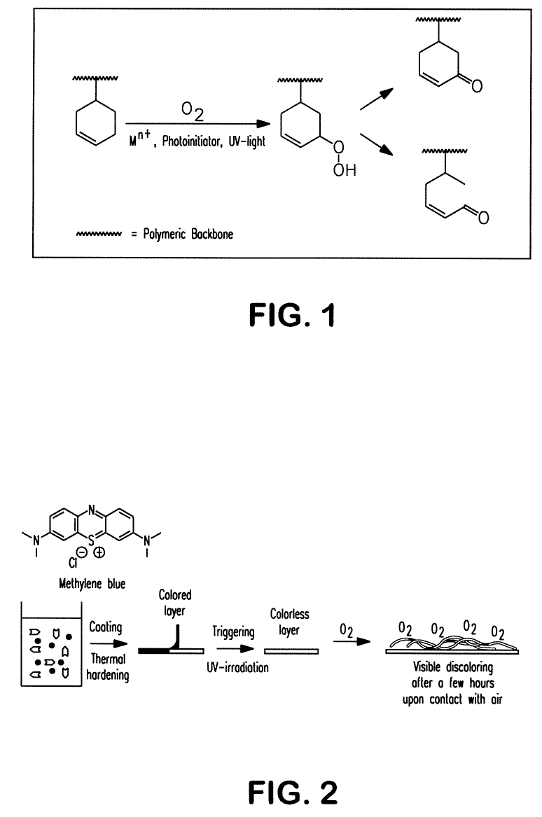

FIG. 1 shows the mechanism of the transition-metal-catalyzed oxidation of cyclic olefins,

FIG. 2 shows the processing and discoloring of a methylene blue indicator solution,

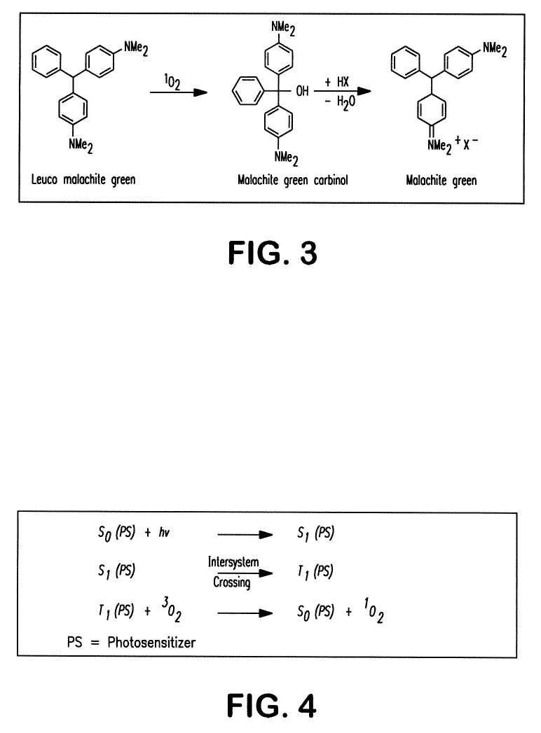

FIG. 3 shows the chemical basis for the oxidation of leuco malachite green with singlet oxygen and subsequent dehydration,

FIG. 4 illustrates the production of singlet oxygen by photosensitization,

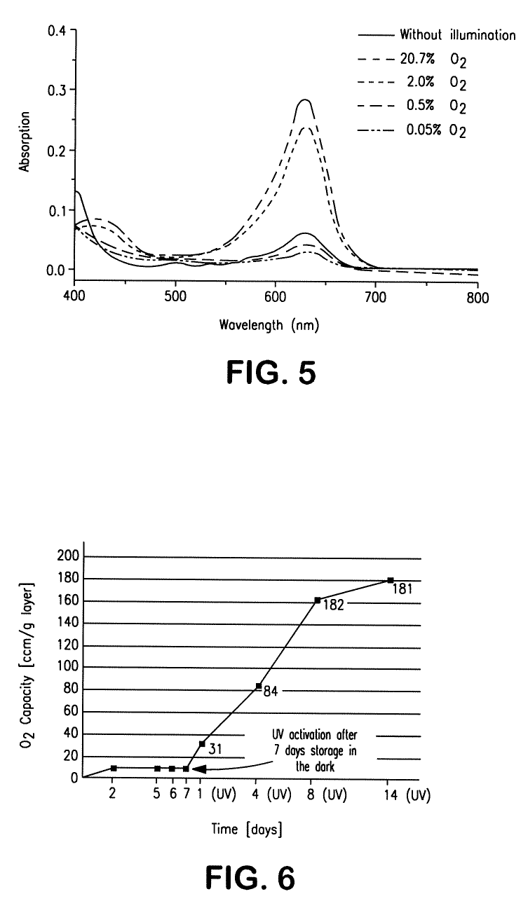

FIG. 5 shows the UV/vis-spectroscopic tracking of the reaction of the LMG/Hp layer as a function of the oxygen concentration before and after the exposure to light,

FIG. 6 shows the oxygen capacity of an oxygen scavenger layer before and after UV triggering,

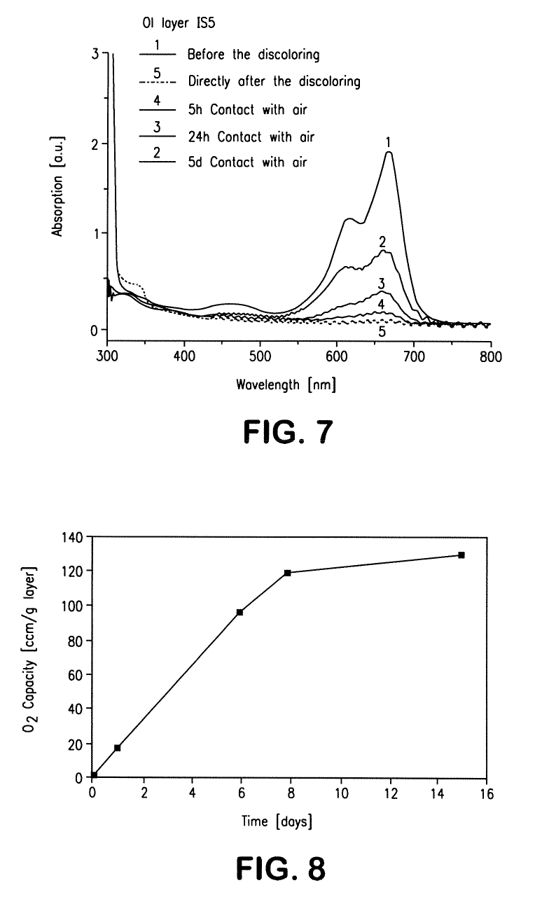

FIG. 7 shows the shows the UV/vis-spectroscopic tracking of the oxygen indicator function of a methylene-blue-based indicator layer,

FIG. 8 shows the oxygen capacity of a scavenger-containing bonding agent layer in a sheet laminate in accordance with example 3, and

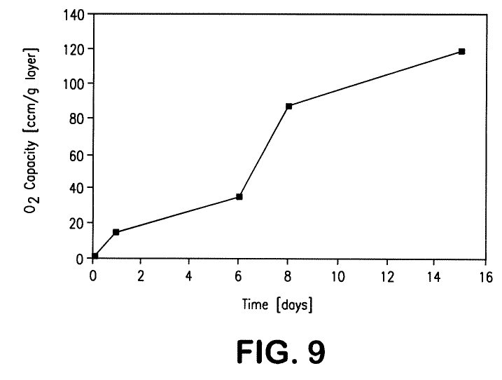

FIG. 9 shows the oxygen capacity of a scavenger-containing bonding agent layer in a sheet laminate in accordance with example 4.

The invention will be described in detail in the following.

A special embodiment of the invention succeeded in developing an oxygen-consuming system (a coating material) that is based, e.g., on the oxidation of a cyclic olefin under cobalt catalysis. This system achieves an oxygen capacity of, e.g., 160 ccm per gram of layer after a measuring time of 8 days (see FIG. 6). In this variant the coating material is designed as a layering coating material and can be applied by a simple layering in different substrates, e.g., packaging materials. Alternatively, the coating material can be designed as a laminating material or other bonding material. In this manner any substrates such as (single) layer materials and/or sheets can be bonded to each other, e.g., laminated to each other. Capacity, reactivity and kinetics are a function of the system used. The decisive difference in comparison to the scavengers of WO 99/48963 and U.S. Pat. No. 6,254,804 resides in the coating materials in accordance with the invention in the preferred embodiments in the using of a polymeric backbone for the oxygen-consuming system as well as in the designing of the coating materials as layering bonding agents or laminating bonding agents. The polymeric backbone consists here in an especially preferable manner of an alkyl-modified hybrid polymer matrix prepared with a sol-gel process. The principle is based on the, e.g., metal-catalyzed hydrolysis of functionalized di- or trialkoxysilanes or other hydrolysable silanes. The process is distinguished in that it can be readily carried out (only one reaction step) under moderate reaction conditions (room temperature). This is a decisive advantage in comparison to the above-cited EMCM polymer process.

As regards the oxidized olefin unit, the selection of a cyclic olefin with a functional group that makes possible a bonding to a polymeric backbone is preferred. This ensures that the oxidation products being produced remain bound to the polymeric network and do not require, as observed for acyclic oxidizable polymers, the addition of absorbers as a consequence of high volatility and a tendency to migration, in order to prevent a contamination of the packaged material. Probable end products of the scavenger process with cyclic olefins are α,β-unsaturated aldehydes and ketones that are formed by radical oxidation at the reactive, mesomerism-stabilized allyl position, as shown by way of example in FIG. 1 for the cyclohexenyl group.

According to the invention hybrid polymers or purely organic polymers are also used as matrix systems for the triggerable indicator systems in accordance with the invention and consisting of a redox dye (such as, e.g., methylene blue or malachite green).

When using methylene blue the layer is colored blue after the application and the hardening. It loses its color after the UV triggering. The layer is then active; upon contact with oxygen it turns blue again (see FIG. 2).

The leuco malachite green/photosensitizer system is described in the following as a further example for indicator systems in accordance with the invention. This system is based on the observation of Kautsky and his coworkers that leuco malachite green (LMG), the leuco form of the triphenylmethane dye malachite green, does not react with atmospheric triplet oxygen but can be oxidized to malachite green by the electronically excited, extremely reactive singlet oxygen. The oxidation of LMG results at first in slightly colored carbinol, that reacts for its part in the presence of acids via a rapid dehydration to the actual dye malachite green (FIG. 3).

The singlet oxygen required for the color reaction indicating oxygen can be produced by photosensitizing. A so-called photosensitizer (PS), that as a rule is a dye itself, absorbs light and as a result is put in an excited state. In a singlet basic state S₀ of the sensitizer this excitation can only take place for its part in singlet states S₁, S₂ etc. In these excited states as a rule a very rapid deactivation without radiation takes place into the lowest excited singlet state S₁, that normally has the longest lifetime. For certain molecules the probability of a spin-prohibited transition from there into the energetically lowest triplet state T₁ is relatively high. The higher the rate of this intersystem crossing in a molecule in comparison to the other possible processes starting from S₁, the higher the quantum yield of the singlet oxygen generation, i.e., the more efficient it is as sensitizer because a collision-induced triplet-triplet annihilation can take place upon the meeting of a molecule in the T₁ state whose energy is always slightly below that of the S₁ state, with oxygen, who basic state is naturally a triplet state. Both reaction partners are moved during their course into a singlet state: the sensitizer into the basic state S₀, and the oxygen molecule on the other hand into the excited singlet state ¹Δ_{g}, that has a higher reactivity in comparison to the triplet state. In addition, even the formation of singlet oxygen in the distinctly energy-richer ¹Σ_{g}⁺ state is sensitized, that, however, has only in extremely short lifetime and very rapidly relaxes into the ¹Δ_{g} state. Therefore, on the whole an absorption of light, a change of the spin state of the sensitizer and a subsequent energy transfer from the excited sensitizer to the oxygen molecule take place, which elevates the oxidation power of the oxygen. How often this process can take place is a function of the photostability of the sensitizer. The entire course is sketched in the attached FIG. 4.

Due to its high singlet oxygen quantum yield of 0.73 on the average, it is advantageous to use hematoporphyrin IX (e.g., in the form of the dihydrochloride) photosensitizer, an iron-free heme, that is also used in medicine for treating malignant neoplasms. Of course, other photosensitizers can also be used instead of it, as is known from the state of the art.

The combination of leuco malachite green (LMG) and photosensitizer offers the possibility of activating the indicator action with the aid of light. Under the total exclusion of light the indicator is stable in its initial state even in the presence of oxygen. However, a constant illumination is required for the indicator reaction since the singlet oxygen is only formed in the simultaneous presence of light and oxygen. This constitutes a difference from the trigger mechanism of the previously described scavenger system, in which a one-time UV irradiation sets a continuous scavenging process in motion.

The functioning of the system LMG/with hybrid polymeric matrix is shown in FIG. 5 as a function of the O₂ concentration before and after the illumination. The threshold value for the O₂ indication is approximately 2% in this exemplary embodiment.

The absorption maximum of the malachite green formed is approximately 621 nm, a distinctly weaker absorption band is at 427 nm. LMG itself has no absorption at all in the visible range.

The coating materials in accordance with the invention can be applied on any substrates in order to perform the function of trapping oxygen there (oxygen scavenger layer) and/or the function of indicating oxygen. Examples for such substrates are packaging materials, e.g., sheets or also flexible or rigid, firm packaging materials. To the extent that these materials are provided for the food area the coating materials of the invention should be admissible under food laws; to this end, e.g., layers can be used that contain methylene blue. Of course, the coating materials can also be used for other purposes than packaging materials; for example, they can be used for industrial sheets, including for the manufacture of flexible OLED's and flexible polymer solar cells.

The binding agent systems in accordance with the invention also have, as stated, the form of coating materials and can be used in order to bond together, e.g., laminate together any substrates such as (individual) layer materials and/or sheets. In particular, they are suitable for laminating plastic sheets or paper sheets. The bonding layer or laminating bonding layer performs the function of trapping oxygen in the form of an oxygen scavenger bonding layer. Examples for substrates that are useful for the invention are flexible packaging materials, e.g., sheets or rigid and firm packaging materials. To the extent that these materials are intended for the food area the bonding agents—coating materials in accordance with the invention should be admissible under the food laws. The coating materials can of course also be used for other purposes.

Naturally, substrates coated or bonded/laminated with the coating materials (layering materials, bonding agents) of the invention can have other coatings that can be selected in accordance with the intended usage. An important example are passive barrier layers for oxygen, as they are known, e.g., from DE 196 50 286 C2 or DE 196 15 192. Composite sheets for the packaging area can accordingly consist, e.g., of a base polymer sheet onto which a layer with oxygen-trapping function (oxygen scavenger layer) in accordance with the present invention and/or a layer with oxygen indicator function in accordance with the present invention, and, as an inner or the outermost layer, a barrier layer, e.g., one such as is disclosed in one of the two above-cited protective rights, are applied.

A. Examples for Oxygen Scavenger Coating Materials and their Use

### EXAMPLE 1

Example for the manufacture of a layering coating material with covalently bound oxygen scavenger.

38 mole % 2-cyclohexenylethyltriethoxysilane are mixed with 38 mole % octyltriethoxysilane, diluted with 1-methoxy-2-propanol and hydrolyzed 60 min at 20° C. (water bath) with 2.05 g (114 mmol) 1 N hydrochloric acid. Subsequently, 24 mole % zirconium propylate EEA (acetoascetic acid) are added and the mixture stirred another 60 minutes. Photoinitiator (1% of solid content), cobalt (350 mg relative to Co⁺⁺), as well as reducing agent (1% of solid content) are added immediately prior to application.

Solid content: 33%

The application takes place with a layer thickness of 4 g/m² on a PET sheet of 12 μm thick; the hardening takes place thermally.

### EXAMPLE 2

Example for the manufacture of a layering coating material with covalently bound oxygen scavenger

Hybrid matrix for the oxygen scavenger system

| Substance | M in g/mol | Mole % |
|---|---|---|
| CHEO | 272.46 | 40-47.5 |
| GLYEO | 278.42 | 40-47.5 |
| 1 n HCl | 18.02 | ½ stoich. (relative to silanes) |
| AsB | 246.33 | 5-20 |
| EAA | 130.14 | |

CHEO and GLYEO are compounded with In hydrochloric acid and agitated hours at room temperature. Then the complexate solution of AsB and EAA is added. The mixture is subsequently agitated until the complete hydrolysis of the silanes.

### Oxygen Scavenger System

| coating material | Photoinitiator | Cobalt salt | Antioxidant |
|---|---|---|---|
| ORMOCER ® matrix | 1 GW % | 2 GW % | 1-5 GW % |

Cobalt salt, antioxidant and photoinitiator are dissolved in n-propanol. The solution is then mixed with hybrid matrix.

### Abbreviations:

CHEO 2-cyclohexenylethyltriethoxysilane
GLYEO 3-glycidoxypropyltriethoxysilane
AsB aluminum-sec-butylate
EAA acetoascetic acid
GW % percent by weight

Photoinitiators that can be used are, e.g., Lucirin TPO or Irgacure 184. Suitable reducing agent/antioxidants are: vitamin E*, Irgafos 168**, Irganox 1076**, Tinuvin 111**, Tinuvin 622, Chimasserb 944**.

According to CIBA: *food approval and **food contact approval Properties of two oxygen scavenger layers (capacities, reactivities and kinetics are system-dependent):

Properties of scavenger system 1: The oxygen absorption of the oxygen scavenger layer before and after UV activation is shown in FIG. 6.

Properties of scavenger system 2: The oxygen absorption of the oxygen scavenger layer after immediate UV activation is shown in FIG. 7.

### EXAMPLE 3

Example for the manufacture of a bonding agent matrix with covalently bound oxygen scavenger.

A coating material was manufactured as indicated in example 1 and adjusted to a solid content of 33%.

The application takes place with a layer thickness of 4 g/m² on a PET sheet 12 μm thick; after a brief pre-drying a second sheet (of paper or plastic such as PET) is supplied. The hardening takes place thermally.

The oxygen absorption of the oxygen scavenger layer after UV activation is shown in FIG. 8.

### EXAMPLE 4

Example for the manufacture of a bonding agent matrix with covalently bound oxygen scavenger.

10-40 wt. % cyclohexenylethyltriethoxysilane and a photoinitiator (1-2 wt % relative to the solid content of the silane-modified matrix), cobalt salt (in an amount of approximately 2 wt. % Co2+) and an antioxidation agent (1-5 wt. %) are worked into an acrylate-based, silane-modified matrix consisting of silane-modified multiple acrylates such as, e.g., bisphenol-A-diacrylate. The application and hardening take place as in example 1.

The oxygen absorption of the oxygen scavenger layer after immediate UV activation is shown in FIG. 9.

### Bonding Agent Application

The application of the bonding agents can take place by a wiper process, e.g., on a corona-pretreated CCP sheet 50 μm thick. The bonding agent coating materials can be applied, e.g., with a 30 μm spiral wiper. The hardening takes place in all instances preferably thermally at temperatures between 40 and 130° C.

### EXAMPLE 5

10-40 wt. % cyclohexenylethyltriethoxysilane, cobalt salt (2% Co²⁺, relative to the solid content of the bonding mass) and an anti-oxidation agent (1-5 wt. % relative to the solid content of the bonding mass) are worked into a commercial laminating bonding agent (e.g., an acrylate-based bonding agent). The layer thickness of the binding agent is adjusted by dilution with solvents (e.g., alcohols). The application is carried out by wiper application or roller application. The hardening takes place thermally.

### EXAMPLE 6

Example 5 was repeated, however, a binding agent based on polyurethane was used.

B. Examples for Oxygen Indicator Layering Coating Materials and their Use

### EXAMPLE 7

### Manufacture of a Layering Coating Material with Embedded Oxygen Indicator (Methylene Blue)

### A. Hybrid Matrix for Methylene Blue Indicator System

| Substance | Amount [g/mole] | G | |
|---|---|---|---|
| A. 200 mmo SR 295 | 325.34 gmol-1 | 70.47 | g |
| B. Ethanol | | 693.00 g = 1000 ml | |
| C. 100 mmol dial-AMEO | 191.32 | 19.13 | g |
| D. 70 mmol N-MeAMMO | 193.32 | 13.53 | g |
| E. 500 mmol water | | 9.0 | g |
| F. 100 mmol triethyl amine | 101.19 | 10.1 | g |

### Test Description:

A is diluted with B and the mixture of C and D added dropwise. The mixture is compounded after five hours agitation with a mixture of E and F and agitated until complete hydrolysis. The coating material solution is subsequently manufactured with a solid content of 30%.

### B. Manufacture of the Layering Coating Material

| Substance | Amount [mmol] | Amount [mg] |
|---|---|---|
| Methylene blue | 0.021 | 8 |
| Rb-S | 0.029 | 15 |
| EDTA | 1 | 292.25 |
| GDMA | | 5000 |
| coating material matrix | | 2000 |
| Ethylene glycol/water | 4:1 (wt. %) | 3000 |

0.7 g dye mixture, ethylene glycol/water and GDMA are weighed in. The mixture is agitated 5 minutes at room temperature and 70 mg Irgacure 184 are subsequently added.

### Abbreviations:

SR 295 pentaerythrite tetraacrylate
Dial-AMEO 3-aminopropylmethyldiethoxysilane

### N-MeAMMO N-methylaminopropyltrimethoxysilane

RB-S riboflavin-5′-monophosphate sodium salt hydrate
EDTA ethylenediamine tetraacetic acid
GDMA glycerol-1,3-dimethacrylate

The properties of the oxygen indicator layer (UV/vis spectroscopic tracking of the reaction of the indicator system (methylene blue system)) are shown in FIG. 7.

### EXAMPLES 8A TO 8C

### Manufacture of Layering Coating Materials with Embedded Oxygen Indicator (Malachite Green)

### A. Manufacture of the Matrices

8a 9.13 g (30.0 mmol) 2-(3-triethoxysilylpropyl)-succinic acid anhydride are compounded with 1.62 g (90.0 mmol) 0.1 N hydrochloric acid and agitated at room temperature until complete hydrolysis and anhydride opening (hydrolysis time: ca. 7 h). The hydrolysate obtained in this manner is mixed with the 20% Mowital solution in a weight ratio of 1:1 (8aa), 1:2 (8ab) and 1:3 (8ac).

Solid contents: 8aa:38.1%; 8ab:31.8%; 8ac:28.4%
hardening after coating (see below) 8aa: 40° C., 1 day: 8ab and 8ac: 80° C., 1.5 h

8b 15.6 g (66.0 mmol) 3-glycidoxypropyltriethoxysilane and 5.42 g (33.0 mmol) propyltrimethoxysilane are diluted with 21.0 g (100 wt. % regarding silanes) ethanol and compounded with 0.246 g (1.00 mmol) aluminum-sec-butylate. After the addition of 2.70 g (150 mmol) 0.1 N HCl the mixture is agitated at room temperature until the hydrolysis has been concluded and the epoxide is completely open.

Hydrolysis time: ca. 24 h
Solid content: 30.6%
Hardening after coating (see below): 80° C., 1 h

8c 18.3 g (60.0 mmol) 2-(3-triethoxysilylpropyl) succinic acid anhydride and 1.98 g (10.0 mmol) phynyltrimethoxysilane are diluted with 9.15 g ethanol and compounded with a 4.91 g (15.0 mmol/6.39 g 76.8% solution in n-propanol) zirconium-n-propylate (4ca) or 4.26 g (15.0 mmol) titanium-n-propylate (4cb). The mixture is subsequently agitated at room temperature with 2.43 g (135 mmol) 0.1 N HCl until complete hydrolysis and opening of the anhydride. 3.24 g (15.0 mmol) diphenylsilane diol are subsequently added and stirred in.

Hydrolysis time: ca. 240 h each
Solid content: 4ca:46.1%; 4cb:46.2%
Hardening after coating (see below): 80° C. each, 30 min.

### B. Manufacture of the Layering Coating Material

All coating materials systems 8a (a-c), 8b and 8c (a and b) were compounded with 1.5 wt. % ascorbic acid as reducing agent and complex ligand and agitated at least 3 hours. The addition of 2.4 wt. % leuco malachite green and 2.4 wt. % HCl (6N) then took place. In conclusion, 500 ppm hematoporphyrin was added as photosensitizer.

### C. Coating Material Application

The application of the coating materials took place by means of wiper processes on a corona-pre-treated CPP sheet 50 μm thick. The layering coating materials were applied with a 30 μm spiral wiper. The draw weight was 12 mm/s. The hardening took place in all instances thermally at temperatures between 40 and 130° C. (see above).

### EXAMPLE 9

### Manufacture of the Coating Solutions

### Coating Solution 9a

| | |
|---|---|
| 0.2-1 mmol | methylene blue |
| 0.1-0.7 mmol | riboflavin-5′monophosphate sodium salt dehydrate |
| 30 ml 10% | ethylene diamine tetraacetic acid disodium salt dehydrate |
| 75 g 25% | polyviol solution (polyviol is a polyvinyl alcohol) |

Methylene blue and riboflavin are dissolved in disodium salt solution and mixed with the polyviol solution. The mixture is ready for use after 4 hours agitation at room temperature.

Viscosity of the solution: 600 mPa.
Hardening: thermal
Layer thickness: 4 g/m²

Properties of the oxygen indicator layer are shown in FIG. 7 as UV/vis spectroscopic tracking of the reaction of the indicator system.

### Coating Solution 9b:

10.0 g Luvimer 100 P (terpolymer containing methacrylic acid) are dissolved in 43.3 g ethanol. The 18.75% polymer solution obtained in this manner is compounded with ascorbic acid as reducing agent and complex ligand and agitated at least 3 hours. The addition of leuco malachite green and acid, preferably in the form of HCl, then takes place. Hematoporphyrin IX is subsequently added as photosensitizer.

### Application of Coating Material

The application of the coating materials took place by wiper process on corona-pre-treated CCP sheet 50 μm thick. In addition, PET sheets were coated. The layering coating materials were applied with a 30 μm spiral wiper. The hardening took place in all instances at room temperature or at elevated temperatures especially between 40 and 130° C.

Many other products can be realized with the novel sheets covered with the layering coating materials of the invention.

In the future, composite materials such as laminated composite sheets can be made available by a combination of the passive barrier layers already developed by the applicant with the novel active barrier layers (scavenger layers) presented in the specification of this invention, which composite materials will be interesting not only for the packaging area but also, in particular, for the industrial sheet area (e.g., encapsulation sheets) for the production of flexible OLEDs and/or flexible polymeric solar cells. Totally new paths for the realization of these flexible structural components based on polymeric sheets can be taken with such combination layers (zero permeation).

1-36. (canceled)

37. A coating material comprising:
a polymeric matrix consisting of an inorganic-organic hybrid polymer; and
a compound capable of consuming oxygen after triggering.

38. The coating material of claim 37, wherein the compound capable of consuming oxygen is a silane compound.

39. The coating material of claim 37, wherein the compound capable of consuming oxygen is an organic polymer, the organic polymer comprising a cyclic olefin.

40. The coating material of claim 37, wherein the matrix is formed utilizing at least one hydrolyzable silane, the hydrolyzable silane selected from the group consisting of a dialkoxysilane and a trialkoxysilane.

41. The coating material of claim 37, wherein the matrix is formed utilizing a silane compound, the silane compound comprising a group accessible to an organic polymerization, an addition reaction, or a condensation reaction.

42. The coating material of claim 41, wherein the group accessible to an organic polymerization, an addition reaction, or a condensation reaction is selected from the group consisting of a vinyl group, allyl group, methactrylic group, or glycidyl group.

43. The coating material of claim 37, wherein the matrix is formed utilizing a silane compound and a metallic alkoxide, the metallic alkoxide selected from the group consisting of aluminum, zirconium, titanium, and tin.

44. The coating material of claim 38, wherein the compound capable of consuming oxygen is covalently bonded to the polymeric matrix.

45. The coating material of claim 37, further comprising a photosensitizer and wherein the compound capable of consuming oxygen is triggered by actinic radiation.

46. A substrate comprising the coating material of claim 37.

47. The substrate of claim 46, wherein the substrate comprises a rigid or flexible packaging material.

48. The substrate of claim 46 further comprising a second coating material, the second coating material comprising an oxygen-indicating component.

49. The substrate of claim 46, further comprising at least one layer that hinders or prevents oxygen transmission.

50. The substrate of claim 49, wherein the outermost layer hinders or prevents oxygen transmission.

51. The coating material of claim 37, wherein the coating material is an adhesive.

52. The coating material of claim 51, wherein the coating material is a pressure sensitive adhesive.

53. The coating material of claim 51, wherein the coating material adheres at least two layers to construct a composite material.

54. The coating material of claim 53, wherein the composite material additionally comprises a second coating material comprising an oxygen-indicating component.

55. The coating material of claim 53, wherein the composite material comprises at least one layer that hinders or prevents oxygen transmission.

56. The coating material of claim 55, wherein the at least one layer is formed from an inorganic-organic hybrid polymer.

57. A coating material comprising:
a polymeric matrix comprising an at least partially organic polymer; and
a compound capable of indicating the presence oxygen after triggering.

58. The coating material of claim 57, wherein the polymeric matrix comprises an organic polymer material that is tack-free upon drying.

59. The coating material of claim 57, wherein the polymeric matrix contains polyvinyl alcohol, methacrylic acid, a polyurethane, or combinations thereof.

60. The coating material of claim 57, wherein the compound capable of indicating the presence of oxygen is incorporated into the matrix via ionic forces, Van-der-Waals forces, hydrogen bridge bonds, or combinations thereof.

61. The coating material of claim 57, wherein the compound capable of indicating the presence of oxygen indicates the presence of oxygen by a color change.

62. The coating material of claim 57, wherein the compound capable of indicating the presence of oxygen is a leuco dye.

63. The coating material of claim 62, wherein the leuco dye is selected from the group consisting of leuco malachite green, methylene blue, or combinations thereof.

64. The coating material of claim 62, wherein the coating material further comprises:
an acid, a reducing agent, a photosensitizer, or combinations thereof;
wherein the compound capable of indicating the presence of oxygen is leuco malachite green.

65. The coating material of claim 62, wherein the coating material further comprises:
a redox system;
wherein the compound capable of indicating the presence of oxygen is methylene blue.

66. The coating material of claim 65, wherein the redox system contains ethylene diamine tetraacetic acid, riboflavin, or combinations thereof.

67. A substrate comprising the coating of claim 57.

68. The substrate of claim 67, wherein the substrate comprises a rigid or flexible packaging material.

69. The substrate of claim 67, further comprising at least one layer that hinders or prevents oxygen transmission.

70. The substrate of claim 69, wherein the at least one layer is formed from an inorganic-organic hybrid polymer.

71. The substrate of claim 69, wherein the outermost layer hinders or prevents oxygen transmission.

72. The coating material of claim 57, wherein the coating material is an adhesive.

73. The coating material of claim 72, wherein the coating material is a pressure sensitive adhesive.

74. The coating material of claim 72, wherein the coating material adheres at least two layers to construct a composite material.

75. The coating material of claim 74, wherein the composite material comprises at least one layer that hinders or prevents oxygen transmission.

76. The coating material of claim 75, wherein the at least one layer is formed from an inorganic-organic hybrid polymer.
